(19) United States
(12) Patent Application Publication
(10) Pub. No.: US 2004/0201489 A1
(43) Pub. Date: Oct. 14, 2004

(54) Sporting article device

(76) Inventor: Steven Mark Levinsohn, Johannesburg (ZA)

Correspondence Address: Dr. David G. Levinsohn, Apt. 601, 700 W Harbor Drive, San Diego, CA, 92101, US

(21) Appl. No.: 10/792,728

(22) Filed: Mar. 5, 2004

(30) Foreign Application Priority Data
Apr. 14, 2003 (ZA) 2003/2898

(51) Int. Cl. G08B 3/00

(52) U.S. Cl. 340/691.6

(57) ABSTRACT

Electronically variable communications are displayed on the outer surface of a sporting article, such as a garment or a vehicle intended for use with, in or at a sporting event. The communications are displayed on a screen of a display device attached to an outer surface of the article.

### BACKGROUND OF THE INVENTION

THIS INVENTION relates to the display of messages. More particularly, it relates to the display of messages on articles intended for use with, in or at a sporting event. The article may have a device attached thereto whereby a variable message may be displayed. Thus the invention relates to an article for use with, in or at a sporting event on which a variable message may be displayed, a method of advertising at a sporting event, and a display device for use with the article.

It is known for sports stars to have patches on their clothing to advertise sponsors. A good example is the patches that are attached to the outer protective clothing that Formula One race drivers wear. These outer protective clothing are adorned with the names, logos, brands and other communications of sponsors and advertisers. When the race driver is in front of television cameras, such as at a press conference, and is wearing a protective garment that has patches thereon, the advertiser whose logo, name or brand appears on a patch on the protective clothing gains television exposure for their product or service because their brand or logo is broadcast to many people that are watching the press conference. These patches, due to their nature, can only display a single message thereon.

### BRIEF SUMMARY OF THE INVENTION

In this specification a “sporting article” means an article intended for use with, in or at a sporting event, which is either a garment or a vehicle.

The term “garment” means an article which is intended to be used on or with the human body and includes clothing and apparel, whether for normal use or specially for sport or protective purposes, footwear, eye glasses, wrist or head bands, caps, helmets, hats, watches and the like which a person can wear or put on. The clothing may be shirts, pants, trousers, jackets, socks, tracksuits, jerseys, sweaters, gowns, capes, or the like.

“Vehicle” includes a vehicle intended to travel on water, on the ground or in the air. Thus, as examples, the vehicle may be a boat or ship, a car or motorbike, or an aeroplane, glider, balloon or the like.

According to the invention there is provided a sporting article which has attached thereto a display device for displaying an electronically variable communication.

Further according to the invention there is provided a method of advertising which includes displaying an electronically variable communication on a display device on a sporting article.

Still further, the invention extends to a method of advertising which includes filming a sporting article in accordance with the invention.

The communication is preferably displayed on an outer surface of the article.

In particular, if the article is a garment, a person wearing the garment may be filmed. The person being filmed may be a player or participant in a sporting event or a spectator.

The communication may be a message, an advertisement, a logo, the name of a TV or radio station, or the like. It will be understood that a particular communication may be a combination of different forms. For example, it could be a combination of an advertisement and a station identifier.

The display device may conveniently comprise an electronically operable display screen which may preferably be flexible, and is also preferably attachable to an outer surface of the article.

The invention thus extends to a display device for use with a sporting article, the display device including an electronically operable display screen.

A driver may be provided for the display screen. The driver may be part of the display device or it may be separate therefrom and be part of an auxiliary unit carried by or attached to the garment and which is connected to the display device by a cable.

The article may further include a storage module in which the various communications to be displayed may be stored.

The article may also include a power supply. This may be a rechargeable battery.

The article may still further include a transfer unit whereby a communication may be transferred thereto, from a remote source, for display by the display device. This may be effected in a wired or wireless manner. Thus, in a preferred embodiment the transfer unit may include a wireless receiver for receiving a transmitted communication.

The article may, in addition, have a transmitter, which may also be wireless, for transmitting data such as the date, time, duration and identity, of advertisements displayed on the or each display device.

The article may, in addition, have a controller, a clock and a timer. Thus, the various communications may be displayed on the display screen at designated times for predetermined durations.

The storage module, the power supply, the transfer unit, the transmitter, the controller, the clock and the timer may each be part of the display device or the auxiliary unit.

The invention is now described by way of example with reference to the accompanying diagrammatic drawings.

### BRIEF DESCRIPTION OF THE DRAWINGS

In the drawings,

FIG. 1 shows a person wearing protective overalls which has a number of display devices thereon, in accordance with the invention;

FIG. 2 shows a schematic block diagram of the display devices;

FIG. 3 shows a racing helmet which has a display device attached thereto in accordance with the invention;

FIG. 4 shows a cricket helmet which has a display device attached thereto in accordance with the invention; and

FIG. 5 shows a racing car in accordance with the invention.

### DETAILED DESCRIPTION OF THE INVENTION

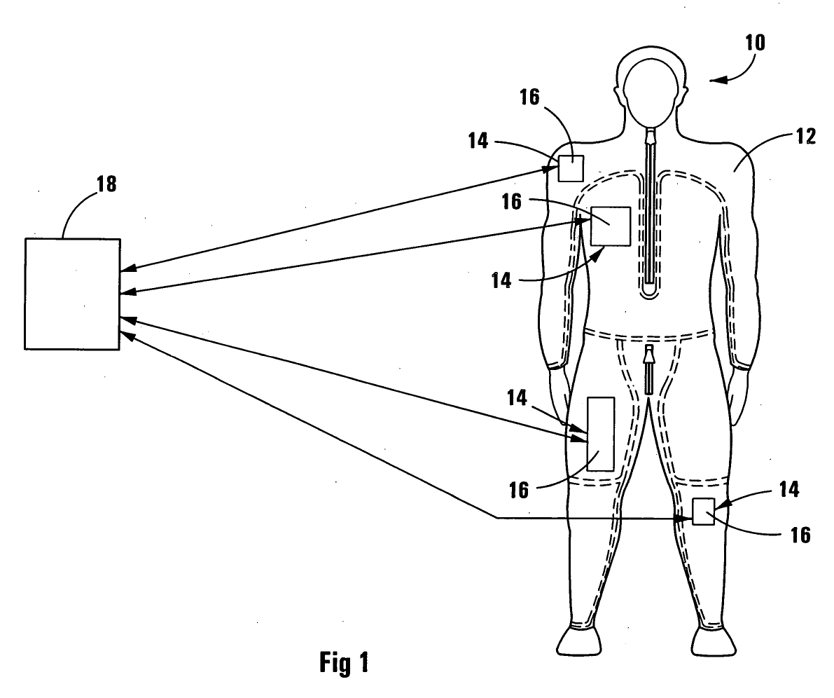

Referring now to FIG. 1, a person is shown, designated generally by reference numeral 10, wearing a sporting article 12 in accordance with the invention, which is a garment. The person 10 is a racing car driver and the garment is a pair of protective overalls. The garment 12 has four display devices 14 with electronic display screens 16. The display screens 16 are of the LED or plasma type, and are flexible. As seen, the display devices 14 are attached to the right front shoulder area, to the right chest area, to the right front thigh and below the left knee area of the garment 12, respectively. Electronically variable communications are displayed on the screens 16, as is explained more fully below. As has been explained above, any communication such as a message, advertisement, logo, station identifier, or the like may be displayed on the screens 16.

The display devices 14 are supplied with the communications, in a wireless manner, from a remote device 18 and also transmit signals to the remote device 18, also in a wireless manner.

The display devices 14 are glued to the overalls 12 from the front with a suitable adhesive. Instead, they may be replaceably removable and may be secured by means of a hook-and-loop fastener. It will be appreciated that they are fairly thin so that they only project slightly from surrounding fabric. They may equally be received in a pocket, from the inside, to be visible through an aperture or clear window in the fabric of the overalls.

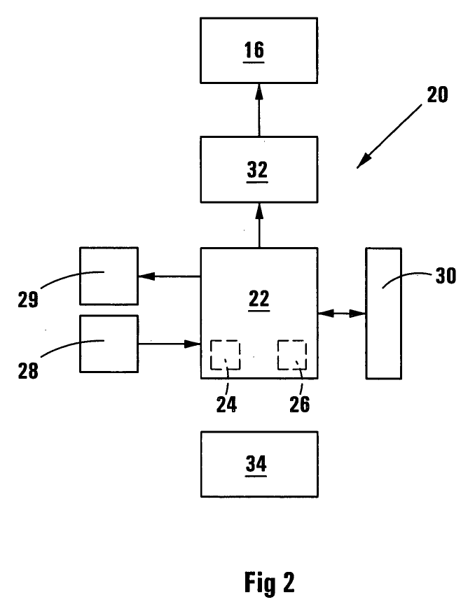

As explained below, each display device 14 has a receiver which receives signals transmitted from the remote device 18. Communications to be displayed on the screens 16 may be varied at will and may be changed or varied as required, depending on the bandwidth of the system. Further, as will be explained below, with reference to FIG. 2, a number of communications may be supplied to the display devices 14 in advance and may then be displayed at predetermined times, for predetermined durations; or they may be displayed in a remotely controlled manner. Further, it will be appreciated that the same communication may be displayed at the same time on all four screens 16, or different communications may be displayed contemporaneously on the different screens. The display devices 14 also each have a wireless transmitter by means of which data such as the time, date, duration and identity of advertisements displayed may be sent to an auditing or monitoring unit in the remote device 18.

Referring now to FIG. 2, a block diagram of the electronic components of the display devices 14 is shown by reference numeral 20. Thus, each display device 14 has a computer based controller 22 which has a clock 24 and a timer 26, a receiver 28, a transmitter 29, a storage module 30, a display screen 16, a driver 32 for the screen 16 and a rechargeable battery 34. As explained above, the various communications are transmitted to each display device 14, are received by the relevant receiver 28 and stored in the storage module 30. Similarly, the controller may be pre-programmed and control signals for programming the controller 22 are also transmitted, in advance, from the remote device 18, received by the receiver 28 and stored in the storage module 30. The controller 22 then supplies the appropriate signals from the storage module 30 to the drivers 32 at the appropriate time (as determined by the clock 24) for the appropriate duration (as determined by the timer 26). If the manner in which communications are displayed is to be controlled remotely at the time the communications are to be displayed, then control signals may be supplied via a further transmitter, which may be incorporated in a television camera, for immediate response by the controller 22. The controller 22 would then not require the clock 24 and timer 26. Further, depending on the bandwidth of the system and the size of the communications, the communications could be transmitted when they are to be displayed, and not in advance, such that the size of the storage module may be decreased or even dispensed with. The communication and control signals may both be received by the same receiver, or by different receivers. Further, as explained above, the date, time, duration and identity of the advertisements displayed are sent by the transmitter 29 to the auditing unit (not shown).

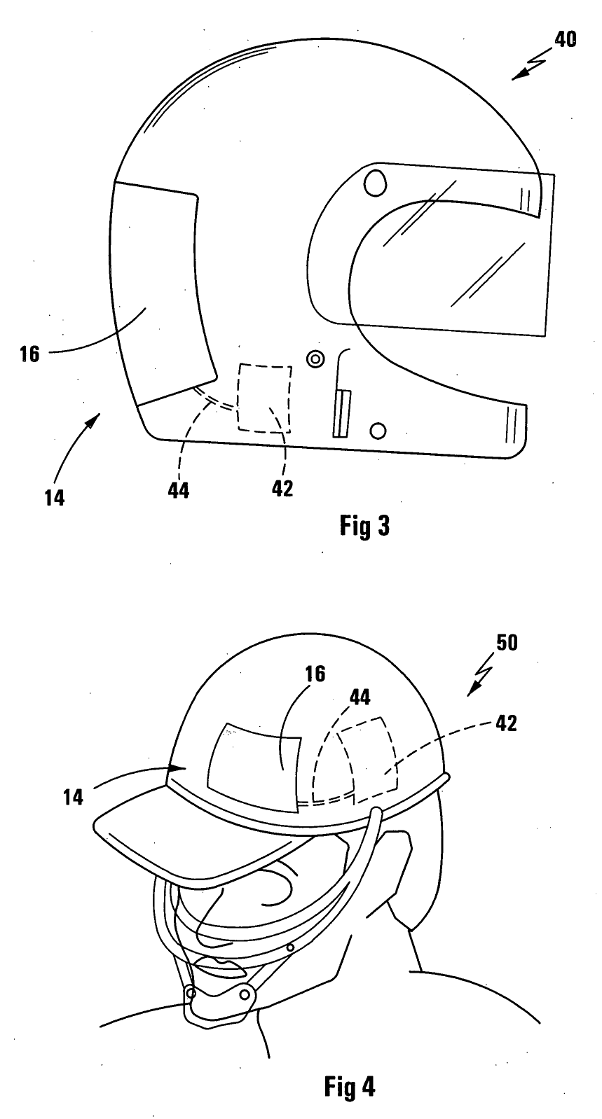

Referring now to FIG. 3, a garment 40 according to the invention, in the form of a racing helmet 40 is shown, with a display device 14 fixed thereon. The helmet 40 has a recess on its rear side, in which the display device 14 is received. The display device 14 comprises a display screen 16, with the other components referred to above being housed in an auxiliary unit 42 which is connected to the screen 16 by a cable 44.

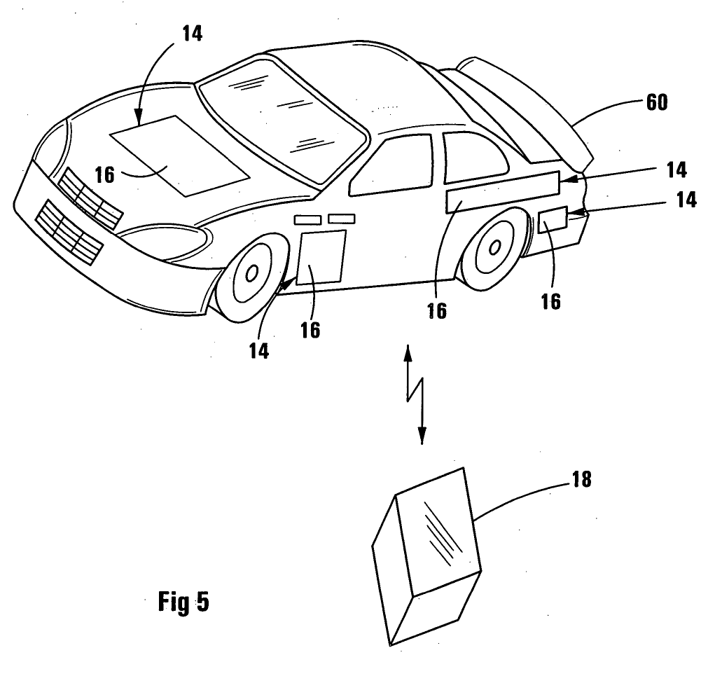

Similarly, FIG. 4 shows a garment 50 according to the invention, in the form of a cricket helmet 50, with a display device 14 fixed thereon. This helmet 50 has a recess on its front side in which the display device 14 is received. Again the display device 14 comprises a display screen 16, with the other components being housed in an auxiliary unit 42 which is connected to the screen 16 by a cable 44.

Referring now to FIG. 5, a racing car is shown, designated generally by reference numeral 60, which has display devices 14 attached to external surfaces thereof in accordance with the invention. The car 60 has a number of display devices 14 with electronic display screens 16. The display screens 16 are of the LED or plasma type, and are flexible. As seen, the display devices 14 are attached to the hood (or bonnet), the front valances, the rear wheel arches, and the rear valances, respectively. Electronically variable communications are displayed on the screens 16, as is explained above. Any communication such as a message, advertisement, logo, station identifier, or the like may be displayed on the screens 16.

The display devices 14 are supplied with the communications, in a wireless manner, from the remote device 18 and also transmit signals to the remote device 18, also in a wireless manner.

The display devices 14 are glued to the external surfaces of the car 60. Instead, they may be replaceably removable and may be secured by means of a magnetized layer. It will be appreciated that they are fairly thin so that they only project slightly from surrounding fabric. They may equally be received in recesses to be flush with surrounding metal.

As explained above, each display device 14 has a receiver which receives signals transmitted from the remote device 18. Communications to be displayed on the screens 16 may be varied at will and may be changed or varied as required, depending on the bandwidth of the system. Further, as explained above, with reference to FIG. 2, a number of communications may be supplied to the display devices 14 in advance and may then be displayed at predetermined times, for predetermined durations; or they may be displayed in a remotely controlled manner. Further, it will be appreciated that the same communication may be displayed at the same time on all the screens 16, or different communications may be displayed contemporaneously on the different screens. The display devices 14 also each have a wireless transmitter by means of which data such as the time, date, duration and identity of advertisements displayed may be sent to an auditing or monitoring unit in the remote device 18.

While a description of the preferred embodiments of the present invention has been given, further modifications and alterations will occur to those skilled in the art. It is therefore understood that all such modifications and alterations be considered as within the spirit and scope of the invention as defined by the appended claims.

1. A sporting article which has attached thereto a display device for displaying an electronically variable communication.

2. The article as claimed in claim 1, in which the display device is attached to an external surface of the article.

3. The article as claimed in claim 1, in which the display device includes an electronically operable display screen.

4. The article as claimed in claim 1, in which the display device is flexible.

5. The article as claimed in claim 1, which includes a storage module in which a communication to be displayed may be stored.

6. The article as claimed in claim 1, which includes a power supply.

7. The article as claimed in claim 1, which includes a transfer unit whereby a communication may be transferred thereto for display on the screen.

8. The article as claimed in claim 7, in which the transfer unit includes a wireless receiver for receiving a transmitted communication.

9. The article as claimed in claim 1, which includes a transmitter for transmitting data to a remote device.

10. The article as claimed in claim 1, which includes a controller that is remotely operable.

11. The article as claimed in claim 1, which includes a clock.

12. The article as claimed in claim 1, which includes a timer.

13. The article as claimed in claim 1, in which the display device is replaceably attached thereto.

14. A method of advertising, which includes displaying an electronically variable communication on a display device on a sporting article.

15. The method as claimed in claim 14, in which the communication is stored in a storage module of the article in advance.

16. The method as claimed in claim 14, in which the communication is displayed on receipt of a control signal from a remote device.

17. The method as claimed in claim 14, in which the communication is displayed at a predetermined time for a predetermined duration.

18. The method as claimed in claim 14, in which the communication is transmitted to a receiver in the article from a remote source when it is to be displayed.

19. A method of advertising, which includes filming a sporting article on which is displayed an electronically variable communication.

20. The method as claimed in claim 19, in which the communication is displayed on an external surface of the article.

21. The method as claimed in claim 19, in which the communication is stored in a storage module of the article in advance.

22. The method as claimed in claim 19, in which the communication is displayed on receipt of a control signal from a remote device.

23. The method as claimed in claim 19, in which the communication is displayed at a predetermined time for a predetermined duration.

24. The method as claimed in claim 19, in which the communication is transmitted to a receiver in the article from a remote source when it is to be displayed.

25. A display device for use with a sporting article, the display device including an electronically operable display screen.

26. The display device as claimed in claim 25, which is attachable to an external surface of the article.

27. The display device as claimed in claim 25, which is flexible.

28. The display device as claimed in claim 25, which includes a storage module in which a communication to be displayed may be stored.

29. The display device as claimed in claim 25, which includes a power supply.

30. The display device as claimed in claim 25, which includes a transfer unit whereby a communication may be transferred thereto for display on the screen.

31. The display device as claimed in claim 30, in which the transfer unit includes a wireless receiver for receiving a transmitted communication.

32. The display device as claimed in claim 25, which includes a transmitter for transmitting data to a remote device.

33. The display device as claimed in claim 25, which includes a controller that is remotely operable.

34. The display device as claimed in claim 25, which includes a clock.

35. The display device as claimed in claim 25, which includes a timer.
